(19) United States
(12) Patent Application Publication
(10) Pub. No.: US 2025/0367680 A1
(43) Pub. Date: Dec. 4, 2025

(54) SEPARATION AND RECYCLING OF LITHIUM-ION BATTERY METALS VIA A MAGNETIC FIELD

(71) Applicant: FLORIDA STATE UNIVERSITY RESEARCH FOUNDATION, INC., Tallahassee, FL (US)

(72) Inventors: Hadi Mohammadigoushki, Tallahassee, FL (US); Munir Humayun, Tallahassee, FL (US); Theo M. Siegrist, Tallahassee, FL (US)

(21) Appl. No.: 19/222,169

(22) Filed: May 29, 2025

Related U.S. Application Data
(60) Provisional application No. 63/652,962, filed on May 29, 2024.

(51) Int. Cl. B03C 1/025; C22B 3/00; C22B 3/02; C22B 3/22; C22B 7/00; C22B 26/12; C22B 47/00; H01M 10/54

(52) U.S. Cl. CPC B03C 1/025; C22B 3/02; C22B 3/22; C22B 7/007; C22B 23/0415; C22B 23/0453; C22B 26/12; C22B 47/00; H01M 10/54; B03C 2201/18

(57) ABSTRACT

Systems and methods are provided for separating mixed metals from one another out of batteries (e.g., lithium ion batteries (LIBs)). Magnetic field gradients can be used to separate mixed metals from one another, and the products of the separation (e.g., lithium (Li), nickel (Ni), manganese (Mn), and/or cobalt (Co)) can be used again in other manufacturing processes, such as to manufacture new LIBs.

### CROSS-REFERENCE TO RELATED APPLICATION

This application claims the benefit of U.S. Provisional Application Ser. No. 63/652,962, filed May 29, 2024, the disclosure of which is hereby incorporated by reference in its entirety, including all figures, tables, and drawings.

### BACKGROUND

Lithium-ion batteries (LIBs) have become one of the most prominent sources of energy storage in portable electronic devices and electric vehicles (EVs). The Department of Energy estimates the LIBs market may grow 10-fold over the next decade due to demand for EVs and other devices. Hence, more waste LIBs from end-of-life battery packs will be generated. Directly disposing the end-of-life LIBs in landfills would cause significant environmental pollution.

### BRIEF SUMMARY

Due to a shortage of the valuable metals used in manufacturing lithium-ion batteries (LIBs) and safety and environmental concerns associated with their mining, effective recycling of end-of-life LIBs is very important. Embodiments of the subject invention provide novel and advantageous systems and methods for separating mixed metals from one another out of batteries (e.g., LIBs). Magnetic field gradients can be used to separate mixed metals from one another, and the products of the separation (e.g., lithium (Li), nickel (Ni), manganese (Mn), and/or cobalt (Co)) can be used again in other manufacturing processes, such as to manufacture new LIBs.

In an embodiment, a method for separating mixed metals from one another out of a battery can comprise: extracting the mixed metals from the battery and into a solution; applying a first magnetic field gradient of a first magnetic field strength to the solution to separate out a first metal of the mixed metals; removing the first metal from the solution; applying a second magnetic field gradient of a second magnetic field strength to the solution to separate out a second metal of the mixed metals, wherein the second magnetic field strength is different from the first magnetic field strength; and removing the second metal from the solution. The system can further comprise: applying a third magnetic field gradient of a third magnetic field strength to the solution to separate out a third metal of the mixed metals, wherein the third magnetic field strength is different from the first magnetic field strength and the second magnetic field strength; removing the third metal from the solution; applying a fourth magnetic field gradient of a fourth magnetic field strength to the solution to separate out a fourth metal of the mixed metals, wherein the fourth magnetic field strength is different from the first magnetic field strength, the second magnetic field strength, and the third magnetic field strength; and/or removing the fourth metal from the solution. The battery can be an LIB. The mixed metals can comprise Li, Ni, Mn, and/or Co. The solution can be a leachate solution. After the step of extracting the mixed metals from the battery into the solution, the method may not use any chemical reagents or generate any hazardous wastes. After the step of extracting the mixed metals from the battery into the solution, the mixed metals can be present in the solution as ions. The method can further comprise, before the step of extracting the mixed metals from the battery into the solution: separating a cathode of the battery from a casing of the battery. The mixed metals can be extracted from the cathode of the battery. The step of extracting the mixed metals from the battery into the solution can comprise using at least one inorganic acid and/or at least one inorganic solvent. After the step of extracting the mixed metals from the battery into the solution, the method may not include any chemical separation, selective precipitation, or solvent extraction.

In another embodiment, a system for separating mixed metals from one another out of a battery can comprise: a container configured to contain a cathode of a battery; at least one solvent configured to extract mixed metals from the cathode of the battery in the container; and a high magnetic field gradient separator positioned proximate to the container and configured to apply magnetic field gradients of varying magnetic field strength to the container. The battery can be an LIB. The mixed metals can comprise Li, Ni, Mn, and/or Co. The solvent can be inorganic. The system can further comprise at least one inorganic acid that can be used in the extraction of the mixed metals from the cathode. The system can include a second container different from “the container” already mentioned, to which the solution can be transferred after the mixed metals are extracted and to which the magnetic field gradients can be applied (and proximate to which the high magnetic field gradient separator can be positioned).

### BRIEF DESCRIPTION OF DRAWINGS

FIG. 1 shows a schematic view of methods for recycling metals from end-of-life lithium ion batteries (LIBs). Part of FIG. 1 shows a traditional process that involves pretreatment (labeled “1”) including separating cathode from casing, metal extraction (labeled “2”) from LIB cathodes using inorganic acids and solvents, and separation (labeled “3”) of the LIB metals from one another via chemical separation, selective precipitation, and/or solvent extraction. FIG. 1 also shows the difference with embodiments of the subject invention (labeled “This Study”), in which instead of step 3 (separation via chemical separation, selective precipitation, and/or solvent extraction), green and chemical-free separation of metal ions is performed via gradient in magnetic fields to separate metals (e.g., lithium (Li), nickel (Ni), manganese (Mn), and/or cobalt (Co)) from each other.

### DETAILED DESCRIPTION

Embodiments of the subject invention provide novel and advantageous systems and methods for separating mixed metals from one another out of batteries (e.g., lithium ion batteries (LIBs)). Magnetic field gradients can be used to separate mixed metals from one another, and the products of the separation (e.g., lithium (Li), nickel (Ni), manganese (Mn), and/or cobalt (Co)) can be used again in other manufacturing processes, such as to manufacture new LIBs.

Used LIBs contain component metals that are needed for the manufacture of new LIBs. However, the metals (e.g., Li, Ni, Mn, and/or Co) must be separated from one another in order to do this. Embodiments of the subject invention can use magnetic field gradients to separate these metals from each other with no chemical reagents needed and no new hazardous wastes produced. A high magnetic field gradient separator can be used. Finite element simulation results show effective separation of Li, Ni, Mn, and Co from LIBs.

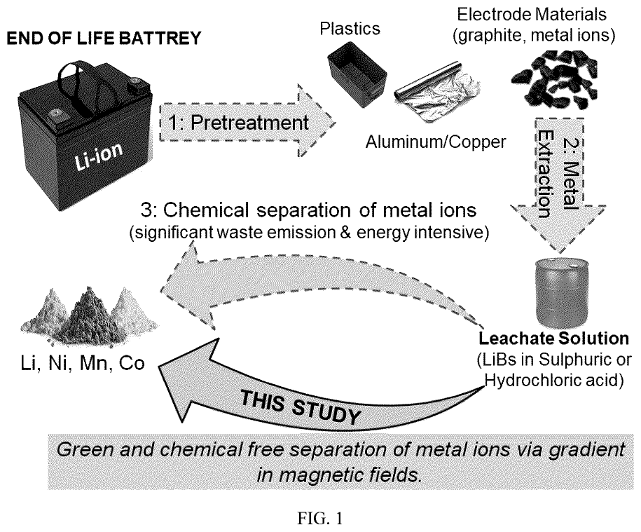

FIG. 1 shows a schematic view of methods for recycling metals from end-of-life lithium ion batteries (LIBs). Part of FIG. 1 shows a traditional process that involves pretreatment (labeled “1”), metal extraction (labeled “2”), and separation (labeled “3”). In embodiments of the subject invention, green and chemical-free separation (labeled “This Study”) of metal ions can be performed via gradient in magnetic fields to separate metals (e.g., Li, Ni, Mn, and/or Co) from each other. In some embodiments, the separation via gradient in magnetic fields can be done on the leachate solution after metal extraction. For example, a different magnetic field strength can be applied for each metal to be extracted, with the associated metal being removed from the solution before applying the next magnetic field strength.

Although LIBs come in different forms, the most popular LIBs contain Li, Ni, Mn, and Co. FIG. 1 shows three conventional stages used for recycling of end-of-life LIB metals (shown as (gray) arrows in the upper part of FIG. 1 (everything above the “This Study” arrow). These traditional stages, and in particular, stage 3 are highly complicated and involve using high amounts of toxic chemicals leading to significant chemical waste emissions and environmental hazards. Therefore, it would be advantageous to recycle metals from end-of-life LIBs using a greener and more environmentally benign separation technique. Embodiments of the subject invention accomplish this.

Remarkably, LIB metal ions possess significantly different magnetic susceptibilities (χ), with Li⁺¹, Mn⁺², Co⁺², and Ni⁺² respectively having magnetic susceptibilities values of −41.6, +14,200, +4,005, and +9,700 (each times 10⁶ cm³/mol). When subjected to an external magnetic field, the magnetic ions experience a net magnetic force whose strength is directly proportional to the magnetic susceptibility (of the ions experiencing the force) and the gradients in magnetic field. The variations in magnetic susceptibilities of LIB metal ions can be harnessed to separate them out from mixtures, which unlocks a green separation technology for LIB metal ions.

Individual ions (e.g., Cu⁺² or Mn⁺²) can undergo magnetophoresis in an inhomogeneous magnetic field, but magnetic partitioning of LIB metal ions from their mixtures has not been previously verified in experiments. Also, there is no theoretical framework in the related art capable of predicting the transport and partitioning of LIB metal ions subject to an external magnetic field.

A continuum scale model for magnetophoresis of metal ions has been developed, and for the first time, partitioning and separation of LIB metal ions has been predicted in the presence of a gradient in the magnetic field. These results provide key information that can significantly advance the understanding of magnetic separation of LIB metal ions. These advances can also provide useful data for magnetic recycling of end-of-life LIBs metals, which will lead to significant chemical waste reduction associated with traditional LIB recycling methods.

Embodiments of the subject invention provide magnetic separation of LIB metal ions via a truly chemical- and touch-free separation method for recycling of LIB metal ions. This means that no solvents or reagents are consumed in magnetic separations, unlike conventional chemical separations, and no new hazardous wastes are produced (at least in the separation step). Therefore, the magnetic separation of ions according to embodiments of the subject invention unlocks a green method for recycling of the LIB metal ions.

Embodiments of the subject invention can enable a closed-loop recycling process in which component metals are recovered from end-of-life LIBs and then used to produce new batteries. In related art methods, component metals of LIBs can be separated through chemical means (e.g., hydrometallurgy methods); however, these methods consume reagents and produce hazardous wastes. By using magnetic fields instead of chemical reagents, only energy is consumed, and no new hazardous wastes are produced. To the best of the knowledge of the inventors, separation of non-ferromagnetic materials using magnetic fields has not been done in the related art.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A method for separating mixed metals from one another out of a battery, the method comprising:
extracting the mixed metals from the battery and into a solution;
applying a first magnetic field gradient of a first magnetic field strength to the solution to separate out a first metal of the mixed metals;
removing the first metal from the solution;
applying a second magnetic field gradient of a second magnetic field strength to the solution to separate out a second metal of the mixed metals, wherein the second magnetic field strength is different from the first magnetic field strength; and
removing the second metal from the solution.

2. The method according to claim 1, further comprising:
applying a third magnetic field gradient of a third magnetic field strength to the solution to separate out a third metal of the mixed metals, wherein the third magnetic field strength is different from the first magnetic field strength and the second magnetic field strength; and
removing the third metal from the solution.

3. The method according to claim 2, further comprising:
applying a fourth magnetic field gradient of a fourth magnetic field strength to the solution to separate out a fourth metal of the mixed metals, wherein the fourth magnetic field strength is different from the first magnetic field strength, the second magnetic field strength, and the third magnetic field strength; and
removing the fourth metal from the solution.

4. The method according to claim 1, wherein the battery is a lithium ion battery.

5. The method according to claim 4, wherein the mixed metals comprise lithium.

6. The method according to claim 1, wherein the mixed metals comprise lithium.

7. The method according to claim 1, wherein the mixed metals comprise nickel.

8. The method according to claim 1, wherein the mixed metals comprise manganese.

9. The method according to claim 1, wherein the mixed metals comprise cobalt.

10. The method according to claim 1, wherein the solution is a leachate solution.

11. The method according to claim 1, wherein, after the step of extracting the mixed metals from the battery into the solution, the method does not use any chemical reagents or generate any hazardous wastes.

12. The method according to claim 1, wherein, after the step of extracting the mixed metals from the battery into the solution, the mixed metals are present in the solution as ions.

13. The method according to claim 1, further comprising, before the step of extracting the mixed metals from the battery into the solution:
separating a cathode of the battery from a casing of the battery,
wherein the mixed metals are extracted from the cathode of the battery.

14. The method according to claim 1, wherein the step of extracting the mixed metals from the battery into the solution comprises using at least one inorganic acid.

15. The method according to claim 1, wherein the step of extracting the mixed metals from the battery into the solution comprises using at least one inorganic solvent.

16. The method according to claim 1, wherein, after the step of extracting the mixed metals from the battery into the solution, the method does not include any chemical separation, selective precipitation, or solvent extraction.

17. A system for separating mixed metals from one another out of a battery, the system comprising:
a container configured to contain a cathode of a battery;
at least one solvent configured to extract mixed metals from the cathode of the battery in the container; and
a high magnetic field gradient separator positioned proximate to the container and configured to apply magnetic field gradients of varying magnetic field strength to the container.

18. The system according to claim 17, wherein the battery is a lithium ion battery.

19. The system according to claim 17, wherein the mixed metals comprise lithium.

20. The system according to claim 17, wherein the mixed metals comprise at least one of nickel, manganese, and cobalt.
